(19) United States
(12) Patent Application Publication
(10) Pub. No.: US 2026/0299588 A1
(43) Pub. Date: Oct. 1, 2026

(54) POOL CLEANER EXTRACTION SYSTEM UTILIZING MAGNETS

(71) Applicant: ZODIAC POOL CARE EUROPE, Belberaud (FR)

(72) Inventor: Marine Descamps, Belberaud (FR)

(73) Assignee: ZODIAC POOL CARE EUROPE, Belberaud (FR)

(21) Appl. No.: 19/576,321

(22) Filed: Mar. 24, 2026

Related U.S. Application Data
(60) Provisional application No. 63/779,455, filed on Mar. 28, 2025.

(51) Int. Cl. G05D 1/244; E04H 4/16; G05D 105/10; G05D 107/00

(52) U.S. Cl. CPC G05D 1/244; E04H 4/1654; G05D 2105/10; G05D 2107/29

(57) ABSTRACT

A pool system includes a self-propelled pool cleaner and a retrieval system. The retrieval system includes a trigger device which is movable within a swimming pool or spa. The pool cleaner includes a sensor for detecting the trigger device and/or a signal from the trigger device without contacting the trigger device. Responsive to the detection of the trigger device or the signal from the trigger device by the sensor, the pool cleaner may initiate an extraction operation.

### REFERENCE TO RELATED APPLICATION

This application claims the benefit of and priority to U.S. Provisional Patent Application No. 63/779,455, filed on Mar. 28, 2025, and entitled POOL CLEANER EXTRACTION SYSTEM UTILIZING MAGNETS, the content of which is hereby incorporated by reference in its entirety.

### FIELD OF THE INVENTION

The invention relates to self-propelled pool cleaners for cleaning water-containing vessels such as swimming pools and spas and more particularly, although not necessarily exclusively, to lift and extraction systems for such pool cleaners.

### BACKGROUND

Self-propelled pool cleaners capable of autonomous or semi-autonomous movement within swimming pools and spas currently exist. The most common of these devices are automatic swimming pool cleaners, which often are either hydraulic or robotic in type. Hydraulic cleaners vary water flow for movement, while robotic cleaners typically employ electric motors to cause motion. Hydraulic pool cleaners, furthermore, subdivide into “pressure-side” and “suction-side” cleaners, with pressure-side cleaners being fluidly connected to outputs of pumps of pool water circulation systems and suction-side cleaners being fluidly connected to inputs of such pumps.

Commonly, a pool cleaner may be removed from a pool or spa for servicing, storage, charging, replacement, and/or other reasons as desired. One existing technique for removing pool cleaners utilizes a hook at the end of a rod, and a user may physically engage the pool cleaner using the hook to move the pool cleaner to a location for removal. However, this technique requires effort by the user to physically engage and move the pool cleaner. Moreover, such techniques may be complicated if the user attempts to engage the pool cleaner while the pool cleaner is moving, as the user must “catch” the moving pool cleaner and furthermore engage the pool cleaner in an appropriate manner.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a pool cleaner for a swimming pool or spa includes a body and a magnetic sensor, and the magnetic sensor is configured to detect a magnetic source of a retrieval system that is movable within a pool.

According to some embodiments, a pool system includes a retrieval system and a pool cleaner. The retrieval system includes a trigger device which is movable within a swimming pool or spa. The pool cleaner includes a sensor configured to detect the trigger device and/or a signal from the trigger device without contacting the trigger device. In certain embodiments, the pool cleaner is configured to initiate an extraction operation responsive to detection, by the sensor, of the trigger device of the retrieval system.

A non-transitory computer readable storage medium may include a plurality of instructions executable by one or more processors, which, when executed on the one or more processors, cause the one or more processors to perform actions including receiving information from a sensor onboard a pool cleaner about the detection of a movable trigger device and/or a signal from the movable trigger device without contacting the trigger device, and responsive to the detection, initiating or causing by the pool cleaner an extraction operation of the pool cleaner.

In some embodiments, a pool cleaner includes a magnetic sensor configured to detect a magnetic source of a retrieval system that is movable within a pool.

In certain embodiments, a pool cleaner includes a sensor configured to detect a trigger device and/or a signal from a trigger device of a retrieval system that is movable within a pool.

According to various embodiments, a pool system includes a retrieval system with a magnetic source movable within a pool and a pool cleaner with a magnetic sensor. The pool cleaner may initiate an extraction operation responsive to detection, by the magnetic sensor, of the magnetic source of the retrieval system.

According to certain embodiments, a method of controlling a pool cleaner includes detecting, by a sensor onboard the pool cleaner, a magnetic source of a retrieval system that is movable within a pool and initiating an extraction operation responsive to detection of the magnetic source.

A non-transitory computer readable storage medium may include a plurality of instructions executable by one or more processors, which, when executed on the one or more processors, cause the one or more processors to perform actions including receiving information from a sensor onboard the pool cleaner about the detection of a movable trigger device and/or a signal from the movable trigger device, and responsive to the detection, initiating or causing by the pool cleaner an extraction operation of the pool cleaner.

In certain embodiments, a pool cleaner system includes a retrieval system with a trigger device movable within a pool and further including a first magnetic source. The pool system includes a pool cleaner with a second magnetic source. The retrieval system may extract the pool cleaner from a pool by magnetically engaging the first magnetic source with the second magnetic source.

According to some embodiments, a method includes moving a trigger device comprising a first magnetic source within a pool and relative to a pool cleaner comprising a second magnetic source and such that the first magnetic source magnetically engages the second magnetic source. The method includes extracting the pool cleaner from the pool using the trigger device while the first magnetic source is magnetically engaged with the second magnetic source.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a top view of a pool system according to embodiments.

FIG. 2 is another top view of the pool system of FIG. 1 according to embodiments.

FIG. 3 is another top view of the pool system of FIG. 1 according to embodiments.

FIG. 4 is another top view of the pool system of FIG. 1 according to embodiments.

FIG. 5 is another top view of the pool system of FIG. 1 according to embodiments.

### DETAILED DESCRIPTION

Described herein are self-propelled pool cleaners for swimming pools, spas, and other recreational water vessels, and more particularly systems and methods for extracting and/or deploying pool cleaners utilizing magnets.

In some embodiments, the systems and methods described herein include one or more magnets associated with a positioning device, such as but not limited to a rod, tether, or other suitable device capable of positioning the one or more magnets within the pool or spa. The pool cleaner may include one or more sensors onboard the cleaner capable of detecting a magnetic field from the one or more magnets. In certain embodiments, responsive to the one or more sensors detecting the magnet, the pool cleaner may stop movement and/or a cleaning cycle if the pool cleaner is moving and/or in a cleaning cycle. Additionally, or alternatively, the pool cleaner may initiate an extraction navigation movement (e.g., causing the pool cleaner to navigate forward on a floor of the pool or spa and/or causing the pool cleaner to climb a wall and/or any other movement, operation, and/or navigation as desired, including for example navigating toward the magnets). Various other control responses may be initiated by the pool cleaner responsive to the detection of the one or more magnets as desired.

Compared to traditional approaches, the systems and methods described herein provide a lift and extraction system that does not require physical engagement with the pool cleaner and/or effort by a user to remove the pool cleaner. Various other benefits and advantages may be realized with the systems, devices, and methods provided herein, and the aforementioned advantages should not be considered limiting.

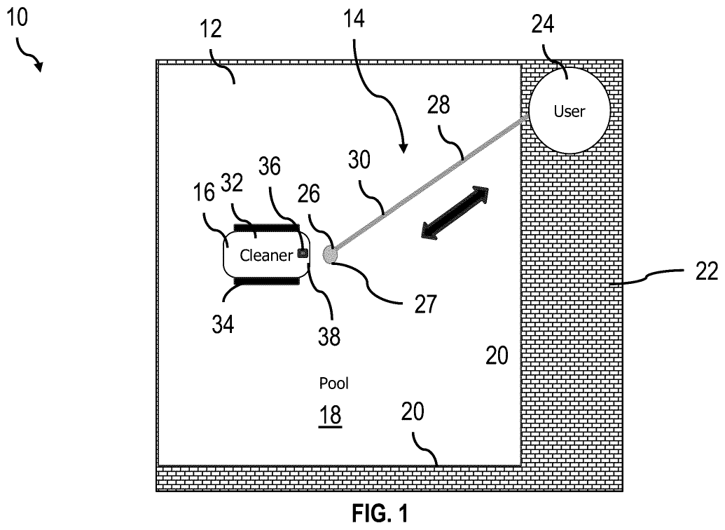

FIGS. 1-5 illustrate an example of a pool system 10 with a swimming pool or spa 12 (hereinafter “pool 12”), a retrieval system 14, and one or more pool cleaners 16 according to embodiments.

The pool 12 generally includes a floor 18 and one or more walls 20, but may have various shapes, sizes, and dimensions, as desired. As such, the pool 12 illustrated in FIGS. 1-5 should not be considered limiting. A pool deck 22 may extend along at least a portion of the pool 12, and a user 24 may use the retrieval system 14 from the pool deck 22 without getting into water of the pool 12. In some embodiments, and as described in detail below, the user 24 may retrieve (or launch) the pool cleaner 16 while the user 24 is on the pool deck 22 utilizing the retrieval system 14.

The retrieval system 14 is provided for initiating a retrieval or deployment of the pool cleaner 16 from and/or into the pool 12. In various embodiments, the retrieval system 14 includes a trigger device 26, which is movable within the pool 12.

The trigger device 26 may have a characteristic and/or generate a signal that is detectable by the pool cleaner 16 as discussed in detail below. In some non-limiting examples, the trigger device 26 is or includes a magnet or magnetic source generating or having a magnetic field that is detectable by the pool cleaner 16. Additionally, or alternatively, the trigger device 26 is or includes a sound source generating or having a sound signal that is detectable by the pool cleaner 16. In the embodiment illustrated in FIGS. 1-5, the trigger device 26 includes a magnetic source 27. Other types of moveable trigger devices 26 may be utilized as desired, and the aforementioned examples should not be considered limiting.

Optionally, the retrieval system 14 includes a positioning device 28 for positioning the trigger device 26 within and/or relative to the pool 12. The positioning device 28 may be various devices or mechanisms suitable for positioning the trigger device 26, such as but not limited to a pole, a rod, a tether, a cable, combinations thereof, and/or as otherwise desired. In the embodiment illustrated in FIGS. 1-5, the positioning device 28 is a pole 30. In some embodiments, and as illustrated in FIGS. 1-5, the positioning device 28 may be manually actuated. As an example, the user 24 may grab and/or otherwise handle the positioning device 28 to move and position the positioning device 28 and thus the trigger device 26 relative to the pool 12. Additionally, or alternatively, the positioning device 28 and/or trigger device 26 may be automatically positioned or moved relative to the pool 12 using various actuation devices or systems as desired.

The pool cleaner 16 may be self-propelled and may be various types of cleaners capable of autonomous or semi-autonomous movement within the pool 12. The number and type of pool cleaners 16 utilized with the pool system 10 should not be considered limiting. In certain embodiments, the pool cleaner 16 may be a robotic cleaner using electrical power for movement and cleaning. Additionally, or alternatively, the pool cleaner 16 may be a hydraulic cleaner utilizing water flow and/or water jets for movement. The pool cleaner 16 may generally include a body or housing 32, and one or more motive elements 34 (e.g., wheels, tracks, rollers, propellers, feet, combinations thereof, etc.) may allow or enable movement of the pool cleaner 16 within the pool 12. In some embodiments, the pool cleaner 16 may include one or more cleaning devices (including but not limited to one or more brush assemblies). A motor, a pump, a filter, a control system (processor and/or memory), and/or various other features or combinations of features may be provided on or within the pool cleaner 16 as desired. As a non-limiting example, the pool cleaner 16 may include a filter, and debris-laden water may enter pool cleaner 16 (e.g., through one or more inlets), with the filter stopping or capturing at least some of the debris before allowing filtered water to exit (e.g., through one or more outlets). In certain embodiments, the pool cleaner 16 includes an on-board power source, such as but not limited to one or more on-board batteries. Non-limiting examples of pool cleaners 16 may include those described in U.S. Pat. Nos. 10,316,534, 9,488,154, 8,578,538, and/or U.S. Patent Publication No. 2014/0303810, all of which are hereby incorporated by reference in their entireties.

In various embodiments, and as illustrated in FIG. 1, the pool cleaner 16 includes one or more sensors 36 for detecting the trigger device 26 and/or a signal from the trigger device 26. Various types of sensors 36 may be utilized suitable for detecting the trigger device 26 and/or a signal from the trigger device 26. As a non-limiting example, the one or more sensors 36 may include a magnetic sensor for detecting the magnetic source and/or magnetic field of the trigger device 26. As another non-limiting example, the one or more sensors 36 may include a sensor for detecting a sound signal from the trigger device 26 when the trigger device 26 is moved in proximity to the pool cleaner 16 and/or within a range at which the trigger device 26 or signal from the trigger device 26 is detectable. In various embodiments, the one or more sensors 36 may detect the trigger device 26 and/or the signal from the trigger device 26 without requiring physical contact between the trigger device 26 and the pool cleaner 16.

The one or more sensors 36 may be provided at various locations on the pool cleaner 16 as desired. As non-limiting examples, the sensor 36 may be provided at an end 38 of the pool cleaner 16 (e.g., a front end or a back end in the direction of travel of the pool cleaner 16) as illustrated in FIG. 1, on a top side of the pool cleaner 16, on a lateral side of the pool cleaner 16, on the housing 32, on a motive element 34, on a filter, on a handle, combinations thereof, and/or as otherwise desired. In some embodiments, the one or more sensors 36 may be at a predefined location on and/or relative to the pool cleaner 16. In other embodiments, other locations may be utilized as desired. In embodiments with a plurality of sensors 36, the plurality of sensors 36 may be provided in various arrangements and/or at various locations on the pool cleaner 16 as desired.

In various embodiments, responsive to the detection by the sensor 36 of the trigger device 26 and/or a signal from the trigger device 26, the pool cleaner 16 (e.g., via the control system of the pool cleaner 16) may automatically initiate one or more extraction operations. The one or more extraction operations may be various operations, movements, navigation control, etc. facilitating retrieval or extraction of the pool cleaner 16 from the pool 12 (or conversely facilitating deployment of the pool cleaner 16 into the pool 12). Non-limiting examples of extraction operations performed by the pool cleaner 16 include one or more of stopping movement of the pool cleaner 16, ending or halting a cleaning cycle of the pool cleaner 16, causing the pool cleaner 16 to navigate along the floor 18 of the pool 12 toward the wall 20 most proximate to the pool cleaner 16 and/or a wall most proximate to the trigger device 26, causing the pool cleaner 16 to navigate forward until the pool cleaner 16 engages the wall 20, causing the pool cleaner 16 to climb the wall 20, optionally to a waterline of the pool 12 and/or at a location at which the user 24 may retrieve the pool cleaner 16 if desired. Other extraction operations may be implemented by the pool cleaner 16 as desired responsive to the detection of the movable trigger device 26.

In some embodiments, the type of extraction operation initiated by the pool cleaner 16 may depend on an operational status of the pool cleaner 16. As a non-limiting example, if the pool cleaner 16 is performing a cleaning cycle, responsive to the sensor 36 detecting the magnetic source or magnetic field of the trigger device 26, the extraction operation may include stopping, halting, and/or pausing the cleaning cycle and/or stopping movement of the pool cleaner 16. As another non-limiting example, if the pool cleaner 16 is stopped or not moving (e.g., at the end of a cleaning cycle or as otherwise desired), responsive to the sensor 36 detecting the magnetic source or magnetic field of the trigger device 26, the extraction operation may include initiating movement or operation of the pool cleaner 16 to travel along the floor 18 and/or climb the wall 20. In various embodiments, the extraction operation may include at least causing the pool cleaner 16 to navigate to at least the waterline of the pool 12 to facilitate access to the pool cleaner 16 and/or extraction of the pool cleaner 16 from the pool 12 by the user 24.

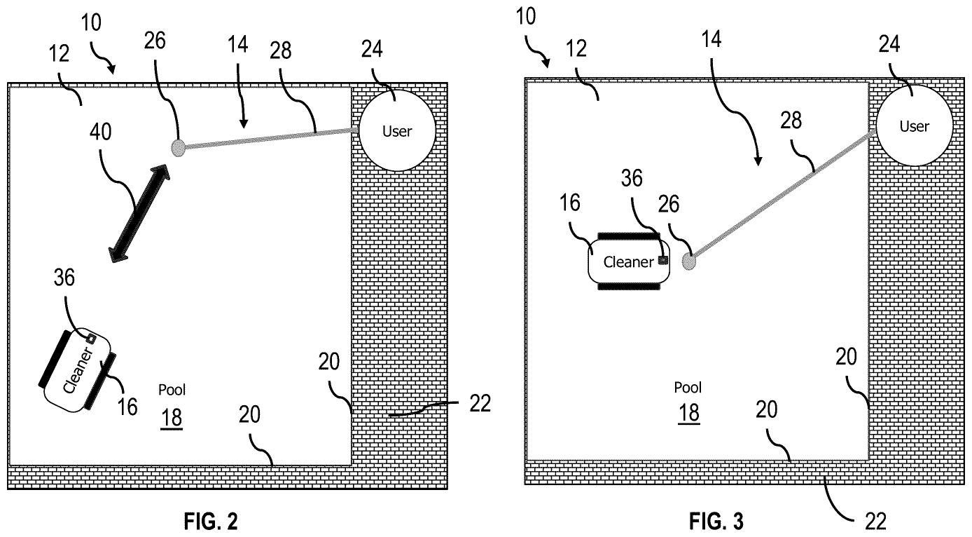

FIGS. 2-5 illustrate a non-limiting example of methods of controlling operation of the pool cleaner 16 using the retrieval system 14. Other methods may be implemented using the systems described herein as desired, and the control illustrated in FIGS. 2-5 should not be considered limiting.

The pool cleaner 16 may be in various operational states when starting the method. In some embodiments, and as illustrated in FIG. 2, the pool cleaner 16 may be moving or navigating within the pool 12, optionally performing a cleaning cycle. In other embodiments, the pool cleaner 16 may be stopped and/or at other locations within the pool 12 as desired.

As illustrated in FIG. 2, the method includes moving the trigger device 26 within the pool 12 (represented by arrow 40). Moving the trigger device 26 includes moving and positioning the trigger device 26 using the positioning device 28 and may be manually implemented (as illustrated in FIGS. 2 and 3) or automatically positioned using various actuation mechanism. In various embodiments, the step of moving the trigger device 26 optionally includes moving the trigger device 26 such that the trigger device 26 passes in proximity to the portion of the pool cleaner 16 with the sensor 36 as illustrated in FIG. 3. Optionally, moving the trigger device 26 includes passing the trigger device 26 with the magnetic source in proximity to a portion of the pool cleaner 16 with a magnetic sensor 36.

The method may include detecting, by the sensor 36 onboard the pool cleaner 16, the trigger device 26 and/or a signal of the trigger device 26 that has been moved in proximity to the pool cleaner 16. As a non-limiting example, the method may include detecting the magnetic source or magnetic field of the trigger device 26 of the retrieval system 14. As another non-limiting example, the method may include detecting a sound signal from the trigger device 26.

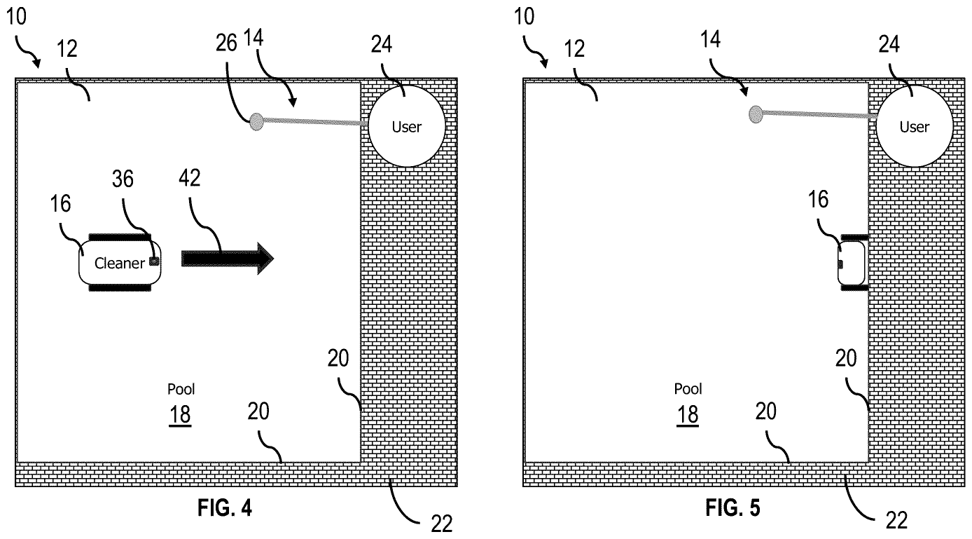

Referring to FIGS. 4 and 5, the method optionally may include initiating or performing, by the pool cleaner 16, an extraction operation responsive to detection of the trigger device 26 or the signal from the trigger device 26 by the sensor 36. In some examples, initiating or performing the extraction operation includes causing the pool cleaner 16 to move forward along the floor 18 (represented by arrow 42 in FIG. 4). Additionally, or alternatively, initiating or performing the extraction operation includes causing the pool cleaner 16 to climb the wall 20 of the pool 12 as illustrated in FIG. 5. Additionally, or alternatively, initiating or performing the extraction operation includes one or more of stopping movement of the pool cleaner 16, ending or halting a cleaning cycle of the pool cleaner 16, causing the pool cleaner 16 to navigate along the floor 18 of the pool 12 toward the wall 20 most proximate to the pool cleaner 16 or most proximate to the trigger device 26, causing the pool cleaner 16 to navigate forward until the pool cleaner 16 engages the wall 20, causing the pool cleaner 16 to climb the wall 20, optionally to a waterline of the pool 12 and/or at a location at which the user 24 may retrieve the pool cleaner 16 if desired, combinations thereof, and/or other extraction operations as desired. In various embodiments, after navigating to the waterline of the pool 12, the pool cleaner 16 may be accessed by the user 24 and/or removed from the pool 12 as desired.

In some embodiments, a method of controlling operation of the pool cleaner 16 using the retrieval system 14 includes utilizing the trigger device 26 with one or more magnets or magnetic sources to extract the pool cleaner 16 from the pool 12. In such embodiments, the method may include engaging the trigger device 26 with the pool cleaner 16 (e.g., by magnetically engaging the pool cleaner 16 using the trigger device 26) and manually extracting the pool cleaner 16 from the pool 12 while the trigger device 26 is magnetically engaged with the pool cleaner 16. In such embodiments, the pool cleaner 16 may include one or more magnetic sources capable of magnetically engaging the trigger device. In various embodiments, the trigger device magnetically engaging the pool cleaner may allow the trigger device to “grab” the pool cleaner for extraction (or deployment or other movement as desired). Additionally, or alternatively, the method may include engaging the trigger device 26 with the pool cleaner 16 (e.g., by magnetically engaging the pool cleaner 16 using the trigger device 26) and automatically extracting the pool cleaner 16 from the pool 12 while the trigger device 26 is magnetically engaged with the pool cleaner 16.

Pool systems described herein provide a solution allowing for easy removal of a pool cleaner from water of a swimming pool or spa without requiring physical engagement with the pool cleaner and/or effort by a user to remove the pool cleaner. Various other combinations of features may be utilized as desired, and the aforementioned examples should not be considered limiting.

Exemplary concepts or combinations of features of the invention may include:
A. A pool cleaner comprising a magnetic sensor configured to detect a magnetic source of a retrieval system that is movable within a pool.
B. The pool cleaner, system, method, or instructions of any preceding or subsequent statement or combination of statements, wherein the magnetic sensor is at a predefined location on a body of the pool cleaner.
C. The pool cleaner, system, method, or instructions of any preceding or subsequent statement or combination of statements, wherein the magnetic sensor is a first magnetic sensor of a plurality of magnetic sensors.
D. The pool cleaner, system, method, or instructions of any preceding or subsequent statement or combination of statements, wherein, responsive to the detection of the magnetic source, the pool cleaner is configured to perform one or more of the following operations:
   i. stopping movement of the pool cleaner;
   ii. ending or halting a cleaning cycle of the pool cleaner;
   iii. causing the pool cleaner to navigate along a floor of the pool toward a wall most proximate to the pool cleaner or most proximate to the magnetic source;
   iv. causing the pool cleaner to navigate forward until the pool cleaner engages a wall; and/or
   v. causing the pool cleaner to climb a wall, optionally to a waterline of the pool.
E. A pool system comprising:
   i. a retrieval system comprising a magnetic source movable within a pool; and
   ii. a pool cleaner comprising a magnetic sensor, wherein the pool cleaner is configured to initiate an extraction operation responsive to detection, by the magnetic sensor, of the magnetic source of the retrieval system.
F. The pool cleaner, system, method, or instructions of any preceding or subsequent statement or combination of statements, wherein the retrieval system further comprises a positioning device, and wherein the magnetic source is associated with the positioning device.
G. The pool cleaner, system, method, or instructions of any preceding or subsequent statement or combination of statements, wherein the magnetic source is attached to the positioning device.
H. The pool cleaner, system, method, or instructions of any preceding or subsequent statement or combination of statements, wherein the positioning device comprises one or more of a rod, a pole, a cable, a tether, and/or any other device suitable for positioning and moving the magnetic source within the pool.
I. A pool system comprising:
   i. a retrieval system comprising a trigger device movable within a pool; and
   ii. a pool cleaner comprising a sensor configured to detect the trigger device and/or a signal from the trigger device without contacting the trigger device, wherein the pool cleaner is configured to initiate an extraction operation responsive to detection, by the sensor, of the trigger device of the retrieval system.
J. The pool cleaner, system, method, or instructions of any preceding or subsequent statement or combination of statements, wherein the retrieval system further comprises a positioning device configured to move and position the trigger device.
K. The pool cleaner, system, method, or instructions of any preceding or subsequent statement or combination of statements, wherein the trigger device is on or attached to the positioning device.
L. The pool cleaner, system, method, or instructions of any preceding or subsequent statement or combination of statements, wherein the positioning device comprises one or more of a rod, a pole, a cable, a tether, and/or any other device suitable for positioning and moving the magnetic source within the pool.
M. The pool cleaner, system, method, or instructions of any preceding or subsequent statement or combination of statements, wherein the trigger device comprises at least one of a magnetic source or a sound source.
N. A method of controlling a pool cleaner, the method comprising:
   i. detecting, by a sensor onboard the pool cleaner, a magnetic source of a retrieval system that is movable within a pool; and
   ii. initiating an extraction operation responsive to detection of the magnetic source.
O. The pool cleaner, system, method, or instructions of any preceding or subsequent statement or combination of statements, wherein initiating the extraction operation comprises one or more of:
   i. stopping movement of the pool cleaner;
   ii. ending or halting a cleaning cycle of the pool cleaner;
   iii. causing the pool cleaner to navigate along a floor of the pool toward a wall most proximate to the pool cleaner or most proximate the magnetic source;
   iv. causing the pool cleaner to navigate forward until the pool cleaner engages a wall; and/or
   v. causing the pool cleaner to climb a wall, optionally to a waterline of the pool.
P. A non-transitory computer readable storage medium comprising a plurality of instructions executable by one or more processors, which, when executed on the one or more processors, cause the one or more processors to perform actions including:
   i. receiving information from a sensor onboard the pool cleaner about the detection of a movable trigger device and/or a signal from the movable trigger device; and
   ii. responsive to the detection, initiating or causing by the pool cleaner an extraction operation of the pool cleaner.
Q. A pool cleaner system comprising:
   i. a retrieval system comprising a trigger device movable within a pool and comprising a first magnetic source; and
   ii. a pool cleaner comprising a second magnetic source, wherein the retrieval system is configured to extract the pool cleaner from a pool by magnetically engaging the first magnetic source with the second magnetic source.
R. A method comprising:
   i. moving a trigger device comprising a first magnetic source within a pool and relative to a pool cleaner comprising a second magnetic source and such that the first magnetic source magnetically engages the second magnetic source; and
   ii. extracting the pool cleaner from the pool using the trigger device while the first magnetic source is magnetically engaged with the second magnetic source.
S. The pool cleaner, system, method, or instructions of any preceding or subsequent statement or combination of statements, wherein extracting the pool cleaner comprises manually extracting the pool cleaner using the trigger device.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with pool cleaners, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

As used herein, the meaning of “a,” “an,” and “the” includes singular and plural references unless the context clearly dictates otherwise.

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. A zero angle refers to an angle of 0° or 180°. Directional references such as “up,” “down,” “top,” “bottom,” “left,” “right,” “vertical,” “horizontal,” “lateral,” “longitudinal,” “front,” and “back,” among others, are intended to refer to the orientation as illustrated and described in the figure (or figures) to which the components and directions are referencing.

The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A pool cleaner for a swimming pool or spa, the pool cleaner comprising a body and a magnetic sensor, the magnetic sensor configured to detect a magnetic source of a retrieval system that is movable within a pool.

2. The pool cleaner of claim 1, wherein the magnetic sensor is at a predefined location on a body of the pool cleaner.

3. The pool cleaner of claim 1, wherein the magnetic sensor is a first magnetic sensor of a plurality of magnetic sensors.

4. The pool cleaner claim 1, wherein, responsive to the detection of the magnetic source, the pool cleaner is configured to perform one or more of the following operations:
stopping movement of the pool cleaner; and/or
ending or halting a cleaning cycle of the pool cleaner.

5. The pool cleaner claim 1, wherein, responsive to the detection of the magnetic source, the pool cleaner is configured to perform one or more of the following operations:
causing the pool cleaner to navigate along a floor of the pool toward a wall most proximate to the pool cleaner or most proximate to the magnetic source;
causing the pool cleaner to navigate forward until the pool cleaner engages a wall; and/or
causing the pool cleaner to climb a wall, optionally to a waterline of the pool.

6. A pool system comprising:
a retrieval system comprising a trigger device movable within a pool; and
a pool cleaner comprising a sensor configured to detect the trigger device and/or a signal from the trigger device without contacting the trigger device, wherein the pool cleaner is configured to initiate an extraction operation responsive to detection, by the sensor, of the trigger device of the retrieval system.

7. The pool system of claim 6, wherein the trigger device comprises a magnetic source, and wherein the sensor is a magnetic sensor.

8. The pool system of claim 6, wherein the retrieval system further comprises a positioning device configured to move and position the trigger device, and wherein the trigger device is associated with the positioning device.

9. The pool system of claim 8, wherein the trigger device is attached to the positioning device.

10. The pool system of claim 8, wherein the trigger device is on the positioning device.

11. The pool system of claim 8, wherein the positioning device comprises one or more of a rod, a pole, a cable, a tether, or combinations thereof.

12. The pool system of claim 8, wherein the trigger device comprises a sound source.

13. The pool system of claim 6, wherein the pool cleaner is configured to perform one or more of the following operations as the extraction operation:
stopping movement of the pool cleaner; and/or
ending or halting a cleaning cycle of the pool cleaner.

14. The pool system of claim 6, wherein the pool cleaner is configured to perform one or more of the following operations as the extraction operation:
causing the pool cleaner to navigate along a floor of the pool toward a wall most proximate to the pool cleaner or most proximate to the trigger device;
causing the pool cleaner to navigate forward until the pool cleaner engages a wall; and/or causing the pool cleaner to climb a wall, optionally to a waterline of the pool.

15. The pool system of claim 6, wherein the trigger device is a first magnetic source, wherein the pool cleaner comprises a second magnetic source, and wherein the retrieval system is configured to extract the pool cleaner from a pool by magnetically engaging the first magnetic source with the second magnetic source.

16. A non-transitory computer readable storage medium comprising a plurality of instructions executable by one or more processors, which, when executed on the one or more processors, cause the one or more processors to perform actions including:
receiving information from a sensor onboard a pool cleaner about a detection of a movable trigger device and/or a signal from the movable trigger device without contacting the trigger device; and
responsive to the detection, initiating or causing by the pool cleaner an extraction operation of the pool cleaner.

17. The non-transitory computer readable storage medium of claim 16, wherein the instructions further comprise instructions causing the one or more processors to perform actions including:
detecting a magnetic source as the movable trigger device; and
initiating an extraction operation responsive to detection of the magnetic source.

18. The non-transitory computer readable storage medium of claim 16, wherein the instructions initiating or causing by the pool cleaner an extraction operation of the pool cleaner comprise instructions for one or more of:
stopping movement of the pool cleaner; and/or
ending or halting a cleaning cycle of the pool cleaner.

19. The non-transitory computer readable storage medium of claim 16, wherein the instructions initiating or causing by the pool cleaner an extraction operation of the pool cleaner comprise instructions for one or more of:
causing the pool cleaner to navigate along a floor of the pool toward a wall most proximate to the pool cleaner or most proximate the trigger device; and/or
causing the pool cleaner to navigate forward until the pool cleaner engages a wall.

20. The non-transitory computer readable storage medium of claim 16, wherein the instructions
initiating or causing by the pool cleaner an extraction operation of the pool cleaner comprise instructions:
causing the pool cleaner to climb a wall, optionally to a waterline of the pool.
